(19) United States
(12) Patent Application Publication
(10) Pub. No.: US 2005/0253453 A1
(43) Pub. Date: Nov. 17, 2005

(54) Crawler track noise dampener

(75) Inventor: Larry E. Miller, Mediapolis, IA (US)

Correspondence Address: CNH AMERICA LLC, INTELLECTUAL PROPERTY LAW DEPARTMENT, PO BOX 1895, MS 641, NEW HOLLAND, PA, 17557, US

(73) Assignee: CNH America LLC

(21) Appl. No.: 10/847,169

(22) Filed: May 17, 2004

(51) Int. Cl. B60B 9/00

(52) U.S. Cl. 305/136

(57) ABSTRACT

A crawler-dozer has a track assembly that includes an idler wheel with an elastomeric ring extending around its outer surface. The ring is continuous, having no breaks in its periphery that permit it to fall off. The ring is not held onto the idler wheel by fasteners but by being force fit on or molded around the periphery of the idler wheel. The ring may be inhomogeneous, having different hardnesses or having reinforcing materials embedded in an elastomeric matrix.

### FIELD OF THE INVENTION

The present invention generally relates to track type implements and, more particularly, to an apparatus for reducing noise levels generated by the tracks during operation.

### BACKGROUND OF THE INVENTION

Crawler tractors and other types of off-highway implements are typically provided with endless tracks on opposite sides thereof. During operation of the implement, noise is generated by the metal tracks as they bang against a drive wheel, front idler, and carrier rollers.

A typical track is comprised of a series of metal links. Adjacent ends of the links are pivotally interconnected by pin and bushing assemblies to form an endless chain. The noise generated by the track arises from the bushing and links banging against the periphery of the wheel, idler, and rollers as the track circulates during movement of the implement. Noise production is transmitted through the implement structure, radiated to the interior and amplified by resonant conditions.

Attempts at reducing the noise level by reducing the mass of the track or by increasing the diameter of the idler wheels for the tracks have been made in the past. Tensioning the track has also been used to reduce the noise level of the track during implement operation by mounting the drive wheel and idler wheel with their axes resiliently positioned with respect to each other in order to hold the chain or track taut.

One partial solution to the noise problem has been to clamp a length of elastomeric material around the periphery of an idler wheel. The elastomeric material contacts the individual links of the crawler track before it contacts the periphery of the idler wheel. The elastomeric material decelerates the links as they approach the idler wheel and reduces their speed of impact. In addition, the contact of the elastomeric material absorbs the high frequencies that are generated by the link-on-idler impact, significantly muffling the sound.

The above efforts notwithstanding, relatively high noise levels continue to be an inherent problem and pose a public nuisance problem during operation of crawler tractors and the like. Furthermore, the elastomeric material requires a separate fastening means that extends around the middle of the length of material. The fastening means requires a fastener-receiving groove in the middle of the length of material that cannot be used to support the bushing and dampen noise. Further, the reduced width due to the fastening means causes accelerated wear.

Thus, there is a need and a desire for an apparatus capable of further reducing the noise level inherent with circulation of an endless track during operation of a crawler tractor and the like.

### SUMMARY OF THE INVENTION

In accordance with a first aspect of the invention, there is provided a noise attenuator that includes an annular elastomeric ring affixed about an idler wheel about which a track is entrained. It is fixed to the idler without separate mechanical fastening means. The idler wheel is supported by the track frame. A recoil assembly is mounted between the idler wheel and drive sprocket to act as a tensioning device and cushion against shock loads. The elastomeric ring is positioned such that pin and bushing assemblies of the track directly and resiliently engage with the periphery of the ring thus reducing noise as the track assembly rotates about the wheel. The elastomeric ring is formed as a single unit, having a solid cross section.

The idler wheel is preferably configured with a central annular rim sized with a diameter greater than other axially spaced rims provided on the idler wheel. The elastomeric ring is formed as a continuous ring, having no beginning or end. In a most preferred form of the invention, the central rim of the idler wheel is provided with an annular channel which defines crown rims on opposite sides thereof. A widthwise portion of the dual crown rims acts as a support for the elastomeric ring. A central portion of the elastomeric ring is received within the channel to prevent lateral shifting of the ring relative to the idler wheel.

The elastomeric ring provides a cushion about the periphery of the idler wheel. The elastomeric cushion absorbs a substantial portion of the energy present in the movement of the chain about the periphery of the idler wheel thereby reducing noise and impact force transmitted to the wheel mount. The ring can be formed separately and later attached to the wheel, or alternatively it can be formed integrally with the wheel, such as by casting the ring directly to the wheel. If formed separately as an endless ring, it has a smaller diameter than the wheel, thereby providing a tight interference fit when it is later forced around the idler wheel.

Numerous other features and advantages of the present invention will become readily apparent from the following detailed description, the accompanying drawings, and the appended claims.

### BRIEF DESCRIPTION OF THE DRAWINGS

FIG. 1 is a fragmentary side elevational view of a track assembly incorporating principles of the present invention.

FIG. 2 is an enlarged side elevational view of the track assembly with parts broken away to illustrate certain features of the present invention.

FIG. 3 is a cross-sectional view taken along line 3-3 of FIG. 2.

FIG. 4 is a plan view of a separately formed elastomeric ring having no beginning or end as it would appear before being forced onto the idler wheel.

FIG. 5 is a cross-sectional view of an alternative and inhomogeneous elastomeric ring 52 having a harder portion and a softer portion.

FIG. 6 is a cross-sectional view of yet another alternative and inhomogeneous elastomeric ring 52 having a fiber reinforcing layer.

FIG. 7 is a cross-sectional view of yet another alternative and inhomogeneous elastomeric ring 52 in which a fibrous reinforcing material is distributed throughout an elastomeric matrix.

FIG. 8 is a cross sectional view through a carrier roller employing an elastomeric ring 52.

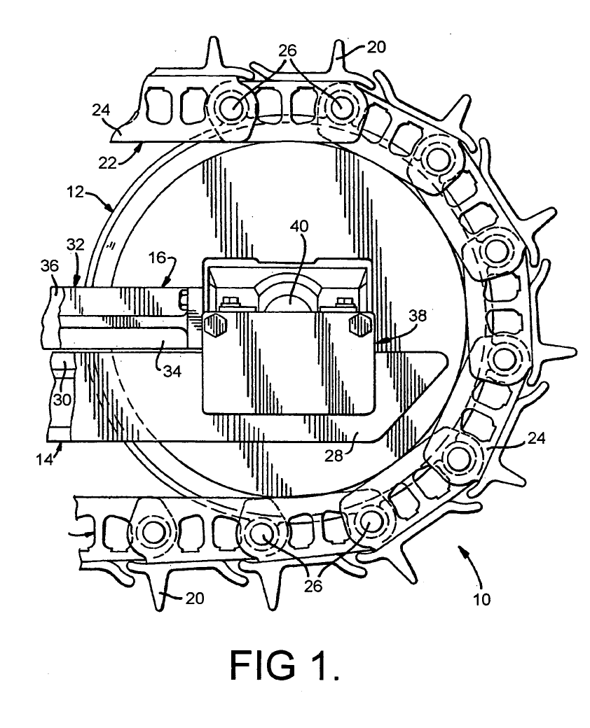

### DETAILED DESCRIPTION OF THE PREFERRED EMBODIMENTS

While the present invention is susceptible of being made in any of several different forms, the drawings show a particularly preferred form of the invention. One should understand, however, that this is just one of many ways the invention can be made. Nor should any particular feature of the illustrated embodiment be considered a part of the invention, unless that feature is explicitly mentioned in the claims. In the drawings, like reference numerals refer to like parts throughout the several views.

Referring now to the FIGURES, there is illustrated a portion of a track assembly for a crawler tractor or other form of off-highway implement. As shown, the track assembly includes an endless track 10 trained about an idler wheel 12 mounted to a track frame 14. The track assembly further includes a recoil assembly 16.

Track 10 comprises a plurality of track shoes 20 secured to an articulated chain 22 in a conventional manner. Laterally spaced pairs of links 24 of the chain 22 are pivotally interconnected by pin and bushing assemblies 26. Each pin and bushing assembly is adapted to engage with a notch or root defined between circumferentially adjacent teeth on a drive wheel (not shown) for driving the track in a conventional manner. The above described elements are all well known in the art.

Track frame 14 is mounted to the crawler tractor in a conventional manner. The track frame 14 has a bifurcated end section including a pair of spaced general horizontal beams 28 and 30 which sandwich the idler wheel 12 therebetween.

The recoil assembly 16 is mounted to the frame 14 to maintain the track 10 in tension. Recoil assembly 16 further allows the idler wheel 12 to recoil and relieves tension on the track to a limited degree in the event that a rock or other hard object is entrapped on the inside of the track. In the illustrated embodiment, recoil assembly 16 includes a resiliently biased yoke 32 including a pair of spaced legs 34 and 36. Legs 34, 36 extend generally parallel to the frame 14 and have the idler wheel 12 mounted therebetween. A pair of idler wheel mounts 38 are secured to the distal end of each leg 34, 36. Each idler wheel mount 38 is preferably formed from a unitary block structure and journals an idler wheel spindle 40 about which wheel 12 rotates.

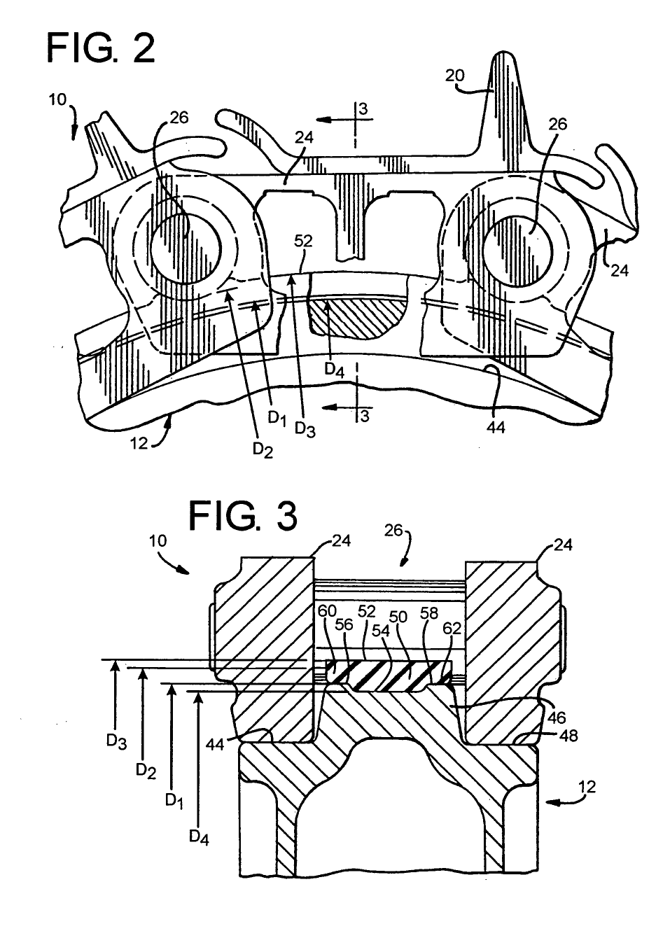

As shown in FIGS. 2 and 3, the idler wheel 12 is configured with a plurality of axially spaced annular rims 44, 46 and 48. Rims 44 and 48 are arranged on opposite sides of the idler wheel 12 for supporting and guiding the links 24 of chain 22 thereabout. As shown, the annular rims 44 and 48 are substantially equal in diameter and are smaller in diameter than the central rim 46.

According to the present invention, a noise reducing or attenuating elastomeric ring 52 is carried by the idler wheel 12. Ring 52 circumferentially surrounds the central rim 46 and is adapted to directly and resiliently engage the pin and bushing assemblies 26 thereby reducing contact noise between track 10 and the wheel 12 as the track rotates about the wheel 12.

As shown in FIG. 3, the central annular rim 46 has a predetermined diameter schematically represented by D₁. The pin and bushing assemblies 26 are disposed such that an underside of each bushing is disposed at a predetermined diameter D₂ as the chain 22 rotates about the wheel 12. D₂ is greater than D₁. Ring 52 is disposed within the space between rim 46 and the underside of the pin and bushing assemblies 26. The outer free surface of ring 52 has a diameter D₃ that is greater than the diameter D₂ of underside of pin and bushing assemblies 26 as they are positioned when wrapped around idler wheel 12. The center of each of diameters D₁, D₂, D₃, and D₄ is the rotational axis of idler wheel 12. Thus, the undersides of each bushing of pin and bushing assemblies 26 compresses the top surface of ring 52 when the chain is wrapped around idler wheel 12. A portion of ring 52 is thereby placed in compression between the pin and bushing assemblies 26 and the outer rim 46 as the track 10 moves about the wheel 12. It is this compression of ring 52 that provides a cushioning and noise attenuating effect.

As shown in FIG. 3, the central rim 46 of idler wheel 12 has an annular channel or groove 54 which opens to the periphery of rim 46 and defines dual crown rims 56 and 58 on opposite lateral sides of channel 54. At least a widthwise portion of each crown rim 56, 58 acts as a support for corresponding and overlying lateral portions 60, 62 of the elastomeric ring 52. Channel 54 on rim 46 receives and accommodates a central portion 50 of the ring 52 circumferentially arranged about the rim 46 such that the cushion 52 has a generally T-shaped cross-section (as shown in FIG. 3) when assembled to the idler wheel 12. With central portion 50 of ring 52 receivably accommodated within channel 54, ring 52 is inhibited against lateral shifting on the annular rim 46 during operation of the tractor.

During operation, compression of the elastomeric ring 52 between the pin and bushing assemblies 26 and the outer rim 46 of wheel 12 attenuates metallic sounds and vibrations normally resulting from the impact between chain 10 and wheel 12. Moreover, recess 54 in the wheel rim 46 interacts with central portion 50 of ring 52 to inhibit inadvertent lateral shifting of the ring or cushion 52 during operation of the implement. Providing the ring 52 between the chain 22 and wheel 12 furthermore reduces impact forces of the idler 12 against the spindle 40.

Substantially the entire width of the outer surface of ring 52 abuts and is compressed by pin and bushing assemblies 26. Lateral portions 60 and 62 and central portion 50 of ring 52 all have the same outer diameter D₃ when stretched to cover rim 46, and all engage the inner surface of pin and bushing assemblies 26.

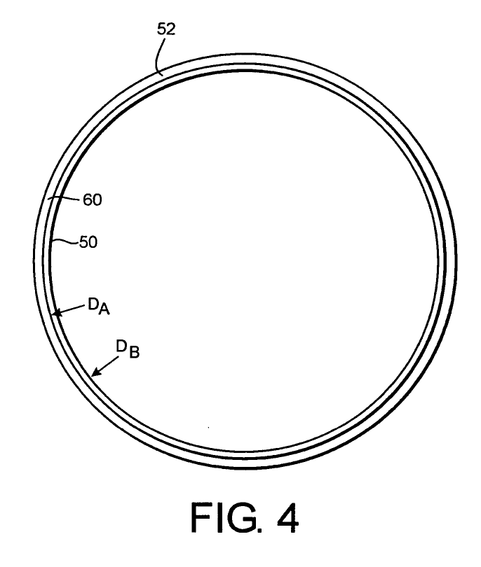

In the preferred form of the invention, ring 52 is cast or molded separately from a liquid elastomeric material that is placed into a mold cavity. This process provides a freestanding elastomeric ring 52 (as shown in FIG. 4) that can be later attached to wheel 12.

A urethane compound which is suitable for the environmental conditions and has a durometer hardness sufficient to allow compression thereof by the pin and bushing assemblies 26 passing about the wheel 12 is one elastomeric material which would suffice to provide the desired cushion and dampening affect of the present invention. Recommended urethanes include “RenCast 6494”, Ren RP-6401-1”, “Ren RP-6400-1”, and “Ren RP-6442” polyurethane systems, which are provided by Freeman Manufacturing and Supply Co., 1101 Moore Road, Avon, Ohio 44011. These materials are identified as having good strength, tear resistance, wear resistance, and hardness in the preferred ranges.

The mold that produces ring 52 of FIG. 4 is sized such that when the ring is initially formed, the inner diameter D_{A} (FIG. 4) of ring portions 60,62, (which will abut crown rims 56,58, respectively, when installed) is less than the outer diameter D₁ (FIGS. 2, 3) of crown rims 56,58 of the wheel 12 on which it is to be installed. When the ring is later elastically stretched, placed around rim 46 and released, however, it contracts such that ring 52 has the same diameters as rim 46. Since D_{A} (as molded) is less than D₁, crown rims 56, 58 and lateral ring portions 60,62 interengage with an interference fit once the ring and idler are assembled.

When the ring is made, inner diameter D_{A} is smaller than diameter D₁ by 0.5 to 4.0 centimeters, preferably by 1.0 to 3.0 centimeters, and even more preferably by 1.5 to 2.5 centimeters.

Similarly, the mold that produces ring 52 of FIG. 4 is sized such that when the ring is initially formed, the inner diameter D_{B} (FIG. 4) of central portion 50 (which will abut the bottom of recess 54 when installed) is less than the outer diameter D₄ (FIGS. 2, 3) of recess 54 of the wheel 12 on which it is to be installed. When the ring is later elastically stretched, placed around rim 46 and released, however, it contracts such that ring 52 has the same diameters as rim 46. Since D_{B} (as molded) is less than D₄, recess 54 and central ring portion 50 interengage with an interference fit once the ring and the idler wheel are assembled.

When the ring is made, inner diameter D_{B} is smaller than diameter D₄ by 0.5 to 4.0 centimeters, preferably by 1.0 to 3.0 centimeters, and even more preferably by 1.5 to 2.5 centimeters.

Once the ring is manufactured, it can be lubricated by a water, soap, detergent or surfactant containing mixture, stretched, and forced over rim 46 and released. It then contracts such that the central portion of ring 52 rests in and is supported by channel 54, and the two lateral portions 60,62 rest on and are supported by crown portions 56,58.

Alternatively, ring 52 can be cast directly on wheel 12. In this process, wheel 12 is placed in a mold that surrounds rim 46. A liquid elastomer, such as any of the liquid urethanes referred to herein, is then poured into the mold and cured. The mold is then removed and wheel 12, together with its integrally formed ring 52, may be used. This method advantageously produces an intimate bond between the outer surfaces of wheel 12 and the ring. This bond reduces or prevents dirt and other materials from working their way between the urethane and the wheel. Dirt between the ring and wheel may abrade the urethane from the inside out, reducing its grip on wheel 12 and eventually causing the ring to fail prematurely. Further, a break or cut in integrally molded ring 52 will not cause the entire ring to detach from wheel 12 and fail.

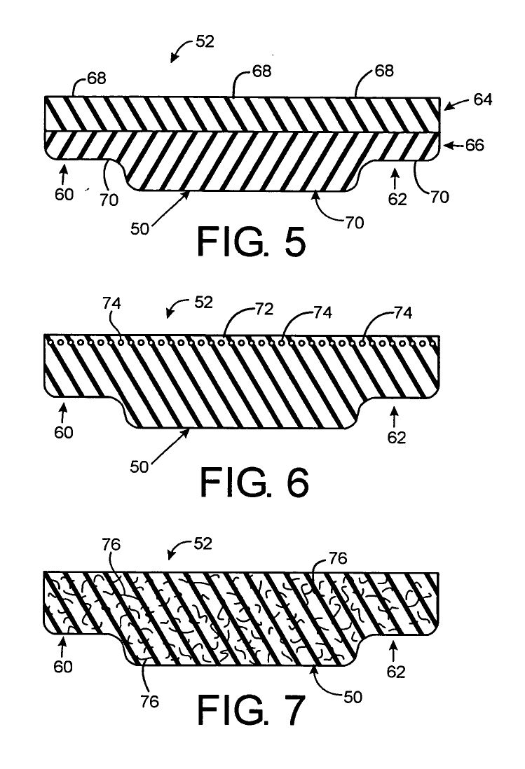

The ring, whether formed separately from wheel 12 or formed integrally with wheel 12, may have a homogeneous structure. Alternatively, it may be formed to have an inhomogeneous structure. Several of these inhomogeneous structures are shown in FIGS. 5-7.

FIG. 5 shows a cross-section of a ring 52 having a first preferred inhomogeneous structure. In FIG. 5, ring 52 includes a first high hardness region 64 and a second low hardness region 66. This two-region construction is indicated by the two different cross-hatched regions shown in FIG. 5.

High hardness region 64 defines an outer wall and surface 68 of ring 52, and is positioned to abut pin and bushing assemblies 26. The high hardness provides a durable wearing surface. It has a hardness of 65-85 on the Shore A scale.

Low hardness region 66 defines an inner wall and surface 70 of ring 52 that faces, is bonded to, or is formed integral with rim 46. It has a hardness of 45-65 on the Shore A scale.

The two layers may be formed by casting or injecting the urethane liquid of which they are made in two separate filling steps, with two separate compositions, either in simultaneous filling steps or in sequential filling steps.

Ring 52 may also be made by casting the ring in a single pour with a single composition, followed by post treatment of the cast material. This post treatment is calculated to cure the outer layer to the proper hardness. This post-treated region then becomes high hardness region 64 when the cure is complete.

While the two regions 64,66 are shown as well-defined adjacent portions of ring 52 in FIG. 5, their hardnesses may change on a gradient as a function of distance, providing a smoother transition from one region to the other with no sudden hardness discontinuities.

FIG. 6 shows a second alternative inhomogeneous structure for ring 52. In FIG. 6, the outer wall 72 of the ring is reinforced with a flexible reinforcement 74 made of elongated fibers. These fibers may be made in a variety of forms including mat, fabric, cords or threads. They are preferably embedded in ring 52 just below the outer surface 72 of the ring and preferably closer to the outer surface of ring 52 facing pin and roller assemblies 26, than they are to the inner surface of ring 52 abutting wheel 52.

FIG. 7 shows a third alternative inhomogeneous structure for ring 52. In the arrangement of FIG. 7, fibers 76 are embedded in the matrix of elastomeric material of ring 52 distributes throughout the matrix material. In all other respects the elastomeric ring 52 of this FIGURE is the same as any of the other elastomeric rings 52 described above.

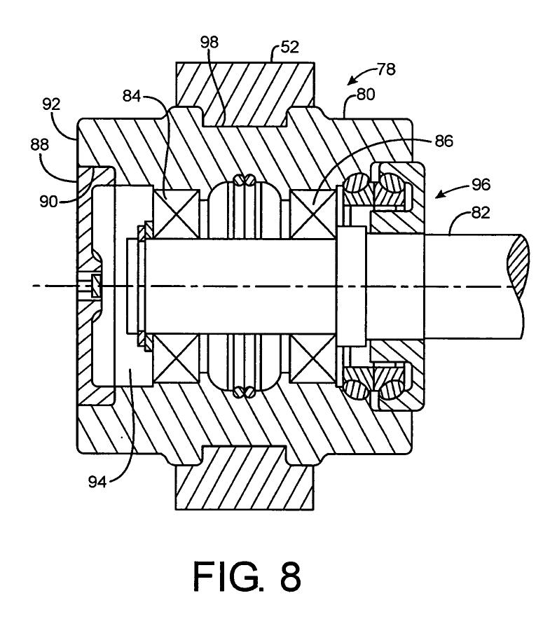

FIG. 8 illustrates an alternative wheel, here shown as a track carrier roller 78 that incorporates the elastomeric ring 52. Track carrier roller 78 includes a hollow cylindrical roller body 80 is supported for free rotation on roller shaft 82. Bearings 84 and 86 support roller body 80 for rotation on shaft 82. An end cap 88 is inserted into aperture 90 in the free end 92 of roller body 80 to enclose the end of the roller body and to provide a sealed chamber 94 that can be filled with grease or other lubricants (not shown). A seal 96 is disposed between shaft 82 and roller body 80 to prevent contaminants such as water and dirt from entering sealed chamber 94 and bearings 84, 86.

Shaft 82 is fixed to the chassis of the crawler such that body 80 rotates about a substantially horizontal axis. Roller 78 is located inside the endless loop of track 10 and supports the slack portion of track 10 that extends from the top of wheel 12. Elastomeric ring 52 is disposed in a recess or groove 98 that extends circumferentially around the outer cylindrical surface of roller 78. Ring 52 is constructed identically to any of the aforementioned rings 52.

From the foregoing, it will be observed that numerous modifications and variations can be effected without departing from the true spirit and scope of the novel concept of the present invention. It will be appreciated that the present disclosure is intended as an exemplification of the invention, and is not intended to limit the invention to the specific embodiment illustrated. The disclosure is intended to cover by the appended claims all such modifications as fall within the scope of the claims.

1. An idler wheel for a track of a tracked vehicle, comprising:
first and second annular rims of substantially equal diameters arranged on opposite sides of the idler wheel for engaging and guiding chain links of the track;
a third central annular rim having a diameter greater than the diameter of the first and second rims, wherein the third rim is disposed between the first and second rims; and
a continuous elastomeric ring extending circumferentially about the third rim, the ring having an overall width and an outer diameter, and further wherein the outer diameter is constant over the overall width of the ring.

2. The idler wheel according to claim 1 wherein the elastomeric ring has two flanking annular portions having inner diameters and a central annular portion having an inner diameter, the central portion being disposed between and formed integral with the two flanking portions, wherein the inner diameter of the central portion is smaller than the inner diameters of the two flanking portions, and further wherein the outer diameters of the two flanking portions and the central portion are the same.

3. The idler wheel according to claim 2, wherein the central rim is provided with an annular recess which accommodates an inner surface of the central portion to prevent lateral shifting of the ring relative to the idler wheel.

4. The idler wheel according to claim 1, wherein the ring is formed integrally with the first, second and third annular rims.

5. The idler wheel according to 4, wherein the ring is inhomogeneous.

6. The idler wheel according to claim 5, wherein the ring includes regions of different hardnesses.

7. The idler wheel according to claim 5, wherein the ring includes fibrous reinforcement.

8. A track assembly for a track-laying off-highway implement, the track assembly comprising:
an articulated chain including a plurality of pivotally interconnected links and pin and bushing means for pivotally interconnecting adjacent links of the chain together;
a rotational wheel about which the chain is engaged, the wheel having axially spaced annular rims of different diameters; and
means for reducing noise generated by the chain passing around the wheel, the noise reducing means comprising a continuous elastomeric cushion affixed circumferentially about a larger of the annular rims on the wheel, the elastomeric cushion having two laterally spaced annular outer sections joined to each other by a central section, the outer sections having inner diameters greater than an inner diameter of the central section to define an outwardly facing continuous circumferential surface defined on an outer surface of all three sections, all three of which being configured to resiliently engage with the bushing means of the articulated chain to reduce noise generation caused by chain contact with the wheel.

9. The track assembly according to claim 8 wherein the larger rim on the wheel is configured with an annular recess which receives an inner portion of the central section of the elastomeric cushion arranged circumferentially thereabout thereby inhibiting lateral shifting of the cushion on the annular rim.

10. The track assembly according to claim 9 wherein the cushion is a continuous annulus.

11. The track assembly according to claim 10, wherein the cushion is formed integrally with the first, second and third annular rims.

12. The track assembly according to claim 10, wherein the cushion is inhomogeneous.

13. The track assembly according to claim 10, wherein the cushion includes regions of different hardnesses.

14. The track assembly according to claim 10, wherein the cushion includes fibrous reinforcement.

15. A crawler tractor having a mobile frame supported by an endless track assembly, comprising:
an endless track including a plurality of link means articulately coupled together by pin and bushing means,
an idler wheel, about which the plurality of link means are wrapped, the idler wheel being mounted on the frame to exert a tensioning force against the endless track, the idler wheel having an outer peripheral surface with an annular channel extending thereabout and between opposite side faces thereof, the surface defining crown rims on opposite lateral sides of the channel; and
noise attenuating means for reducing noise caused by the plurality of links passing around the wheel, the noise attenuating means comprising an elastomeric ring having an overall width, the ring directly and resiliently engaging the bushing means over substantially its entire width, thereby reducing contact noise between the wheel and the plurality of links as the endless track rotates around the wheel.

16. The track assembly according to claim 15 wherein the ring is continuous.

17. The track assembly according to claim 16, wherein the cushion is molded to the idler wheel.

18. The track assembly according to claim 15, wherein the ring is inhomogeneous.

19. The track assembly according to claim 18, wherein the ring includes regions of different hardnesses.

20. The track assembly according to claim 18, wherein the ring includes fibrous reinforcement.
